(19) United States
(12) Patent Application Publication
(10) Pub. No.: US 2016/0078670 A1
(43) Pub. Date: Mar. 17, 2016

(54) IMAGE PROCESSING METHOD

(71) Applicants: XYZPRINTING, INC., NEW TAIPEI CITY (TW); KINPO ELECTRONICS, INC., NEW TAIPEI CITY (TW); CAL-COMP ELECTRONICS & COMMUNICATIONS COMPANY LIMITED, NEW TAIPEI CITY (TW)

(72) Inventors: CHUAN-FENG WU, NEW TAIPEI CITY (TW); MENG-GUNG LI, NEW TAIPEI CITY (TW); YI-HSUN LEE, NEW TAIPEI CITY (TW); HUA LIU, NEW TAIPEI CITY (TW); CHUN-FAN TAI, NEW TAIPEI CITY (TW)

(21) Appl. No.: 14/566,937

(22) Filed: Dec. 11, 2014

(30) Foreign Application Priority Data
Sep. 15, 2014 (TW) 103131826

(51) Int. Cl. G06T 15/20; G06T 5/00; G06T 11/00

(52) U.S. Cl. CPC G06T 15/205; G06T 11/001; G06T 5/002

(57) ABSTRACT

An image processing method includes following steps. A two-dimension (2D) image is obtained; a gray-scale processing is performed; a smoothing processing is performed; and a height calculation for constructing a three-dimension (3D) model is performed. The 2D image is automatically converted into a 3D model, even an user does not have 3D model construction skill. Furthermore, the 3D model constructed has less noise and more obvious image features.

### FIELD OF THE INVENTION

The technical field relates to image processing and more particularly related to image processing for converting two-dimension images into three-dimension models.

### BACKGROUND

3D printing is a popular technology in recent years. With 3D printing technology, users may design and create 3D models and use 3D printers to embody 3D models. By such, makers can quickly build physical objects of necessary elements or models, instead of building expensive moulds for manufacturing. With these advantages, the 3D printing technology is honored as “the Third Industrial Revolution” and even brings Maker Movement.

However, special software and technology are necessary for building a three-dimension model. It is not easy for user without professional training to complete such task and that forms a bottleneck for promoting 3D printing technology.

To solve this problem, an image processing method for automatically converting two-dimension images into three-dimension models is proposed. In the method, the outlines of a two-dimension image (e.g. the color two-dimension image in FIG. 7) input by a user are converted into a plurality of lines. A height value corresponding to each area surrounded by each line is calculated respectively and then, a three-dimension model is constructed by the plurality of lines and the height values. After that, the user may transmit the three-dimension model to a three-dimension printer to perform three-dimension printing to build a physical three-dimension model (as the physical three-dimension model illustrated in FIG. 8).

Specifically, the two-dimension image is composed of a plurality of pixels with different brightness values and the three-dimension model is composed of lines. Because they have different components, in such image processing method, a brightness-line transformation process is performed first for transforming the plurality of pixels into the plurality of lines, i.e. the outlines being transformed into the plurality of lines, before other processing is performed.

However, when the two-dimension image includes lots of high-frequency components, e.g. complicated background or details like complicated gradations of light and shade, the three-dimension models generated by conventional methods that still transform high-frequency components into the plurality lines to construct the three-dimension models include a large amount of complicated lines. When such lines are printed via three-dimension printing into physical objects, these lines form noises of the three-dimension model and cause the three-dimension model having bad visual effect.

Next, technical problems related to aforementioned solutions are explained as follows. A user inputs a color two-dimension image as illustrated in FIG. 7, uses conventional image processing methods to convert the two-dimension image into a three-dimension model, and uses three-dimension printing to create a physical three-dimension model as illustrated in FIG. 8. The physical three-dimension model as illustrated in FIG. 8 created from aforementioned methods have lots of burrs and gaps that are noises of the physical three-dimension model and thus cause the physical three-dimension model having bad visual effect. In other words, the interference of such noises prevents the physical three-dimension model to effectively show image features of the two-dimension image like facial profile, depth of facial features or gradation of light and shadow.

Therefore, there is a need to find out a better and more effective solution to handle such problems.

### SUMMARY OF INVENTION

The disclosure is directed to an image processing method for converting two-dimension images into three-dimension models.

One of the exemplary embodiments, an image processing method includes following steps. A) A two-dimension image is obtained. B) A gray-scale processing is applied to the two-dimension image. C) A smoothing processing is applied to the two-dimension image. D) A height value corresponding to each pixel is calculated respectively according to pixel values of the plurality of pixel values of the two-dimension image. The pixel value of each pixel is inversely proportional to the corresponding height value. E) A three-dimension model is constructed according to the two-dimension model and the plurality of height values.

The image processing method according to the disclosed example may be used for automatically converting a two-dimension image into a three-dimension model. Even a user does not have skill for building three-dimension models, a three-dimension model can still be easily constructed with the disclosed example. Besides, the lines are effectively simplified using the image processing method according to the disclosed example so that physical three-dimension models made by such three-dimension models have less noises and have deeper image features.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a diagram of an image processing system according to a first embodiment of the present disclosed example;

FIG. 2 is a flowchart of an image processing method according to a first embodiment of the present disclosed example;

FIG. 3 is a flowchart of an image processing method according to a second embodiment of the present disclosed example;

FIG. 4 is a flowchart of an image processing method according to a third embodiment of the present disclosed example;

FIG. 5 is a flowchart of step S410 in the third embodiment of the present disclosed example;

FIG. 6 is a flowchart of step S4102 in the third embodiment of the present disclosed example;

FIG. 7 is a color two-dimension image inputted by a user;

FIG. 8 is a physical three-dimension model created from the related art image processing method;

FIG. 9 is a gray-scale two-dimension image created from applying the gray-scale processing to the color two-dimension image of FIG. 7;

FIG. 10 is a three-dimension model created from applying the height calculation processing and the height-stretching processing to the smoothed two-dimension image;

FIG. 11 is a smoothed two-dimension image created from applying the resolution-lowering processing to the gray-scale two-dimension image of FIG. 9;

FIG. 12 is a grid smoothed two-dimension image created from performing the grid processing to the gray-scale two-dimension image of FIG. 9;

FIG. 13 is a three-dimension model having net-shape trenches created from applying the height calculation processing and the height-stretching processing to the grid smoothed two-dimension image of FIG. 12;

FIG. 14 is a non-slice three-dimension model created from applying the height calculation processing and the height-stretching processing to the smoothed two-dimension image of FIG. 11;

FIG. 15 is a slice physical three-dimension model created from printing the slice three-dimension models; and

FIG. 16 is a slice three-dimension model created from applying the slicing processing to the slice physical three-dimension model of FIG. 15 according to the thickness.

### DETAILED DESCRIPTION OF EMBODIMENT

In the following description, a preferred embodiment is explained with associated drawings.

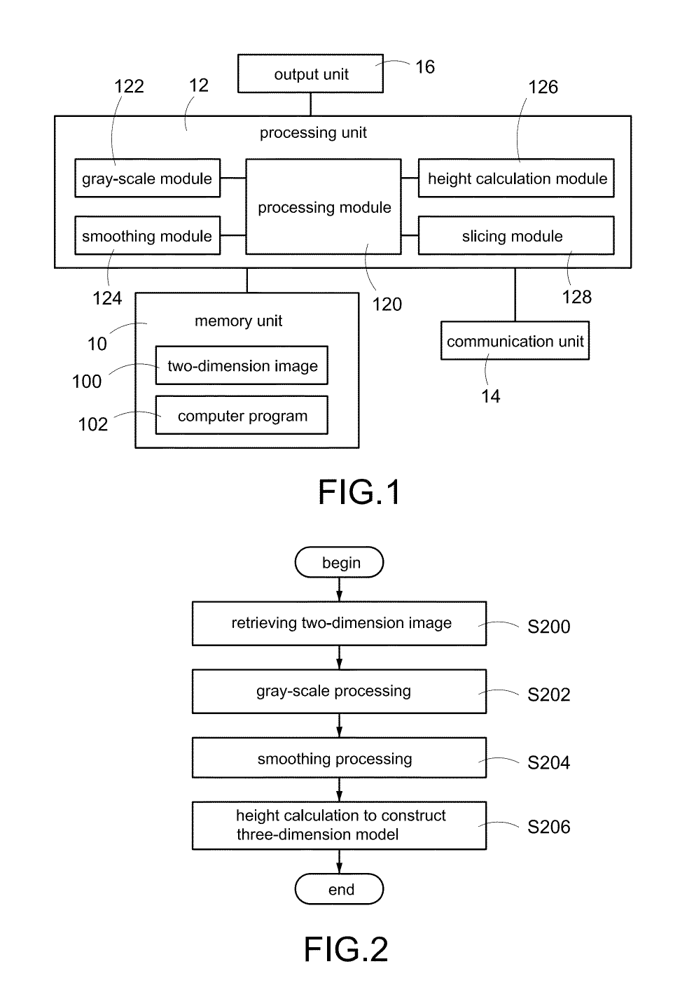

First, please refer to FIG. 1, which illustrates an image processing system diagram according to a first embodiment of the disclosed example. In this embodiment, an image processing method is provided. The image processing method may be implemented with an image processing system 1. As illustrated in FIG. 1, the image processing system 1 may include a memory unit 10 and a processing unit 12.

The memory unit 10 is used for storing data. Specifically, the memory unit 10 stores a two-dimension image 100. The type of the two-dimension image 100 may be, but not limited to, a color image, a gray-scale image, or a half-tone image. Preferably, the two-dimension image 100 is stored in the memory unit 10 as an image file. The format of the image file may be BitMap (BMP) Joint Photographic Experts Group (JPEG), or Tagged Image File Format (TIFF), but is not limited to only these example formats.

The processing unit 12 is electrically connected to the memory unit 10 for converting the two-dimension image 100 into a three-dimension model. Specifically, the processing unit 12 includes a processing module 120, a gray-scale module 122, a smoothing module 124, a height calculation module 126 and a slicing module 128. In addition, the processing module 120 is connected to the gray-scale module 122, the smoothing module 124, the height calculation module 126 and the slicing module 128.

The processing module 120 retrieves the two-dimension image 100 and controls each module. The gray-scale module 122 applies a gray-scale processing, if the type of the two-dimension image 100 is a color image, to the two-dimension image 100 to generate a gray-scale two-dimension image 100. The smoothing module 124 applies smoothing processing to the gray-scale two-dimension image 100 to generate smoothed two-dimension image 100. The height calculation module 126 applies a height calculation to the smoothed two-dimension image 100 to calculate multiple height values of the smoothed two-dimension image 100. The processing module 120 constructs a three-dimension model according to the smoothed two-dimension image 100 and the multiple height values to generate and store a three-dimension model file. The three-dimension file may have the format of Standard Template Library (STL), a Virtual Reality Modeling Language (VRML), but may also have other formats. The slicing module 128 applies a slicing processing to the three-dimension model for three-dimension printing to generate a slice three-dimension model.

Please be noted that the processing module 120, the gray-scale module 122, the smoothing module 124, the height calculation module 126 and the slicing module 128 may be implemented by hardware modules like electronic circuit or integrated circuit with recorded digital circuits, or implemented by software modules, e.g. Application Programming Interface (API), but are not limited to aforementioned examples.

In another embodiment, the memory unit 10 may further store a computer program 102. The computer program 102 contains computer-executable program codes. When the processing unit 12 executes the computer program codes for performing functions of the processing module 120, the gray-scale module 122, the smoothing module 124, the height calculation module 126 and the slicing module 128.

In another embodiment, the image processing system 1 may be a server and further includes a communication unit 14. The processing unit 12 is electrically connected to the communication unit 14 and connects to the Internet via the communication unit 14. Specifically, the processing unit 12 may receive the two-dimension image 100 from an user on the Internet via the communication unit 14 and may store the two-dimension image in the memory unit 10. After the processing unit 12 converts the two-dimension image 100 into the three-dimension model file, the three-dimension model file is transmitted back to the user via the communication unit 14. With such, the image processing system 1 may provide cloud service for converting two-dimension images to three-dimension models.

In another embodiment of the disclosed example, the image processing system 1 further includes an output unit 16. The output unit 16 is electrically connected to the processing unit 12 for outputting the converting/converted three-dimension models. Preferably, the output unit 16 is a display device like a LED display for displaying the three-dimension models, but the disclosed example is not limited to such examples. By such, the user may check the three-dimension model via the display device instantly and handles following operations.

In another embodiment of the disclosed example, the output unit 16 is a three-dimension printer. The processing unit 12 may read the three-dimension model file to retrieve the three-dimension model. Next, the slicing module 128 of the processing unit 12 applies slicing processing to the three-dimension module. The processing unit 12 transmits the sliced three-dimension model to the three-dimension printer for performing three-dimension printing to create a physical three-dimension model. By such, the user only needs to input the two-dimension image 100 to obtain the three-dimension model.

Please refer to FIG. 2, which is an image processing method according to the first embodiment of the disclosed example. The image processing method in this embodiment is mainly implemented by the image processing system 1 as illustrated in FIG. 1. After the processing unit 12 executes the computer program, the following steps are performed.

Step S200: retrieve the two-dimension image.

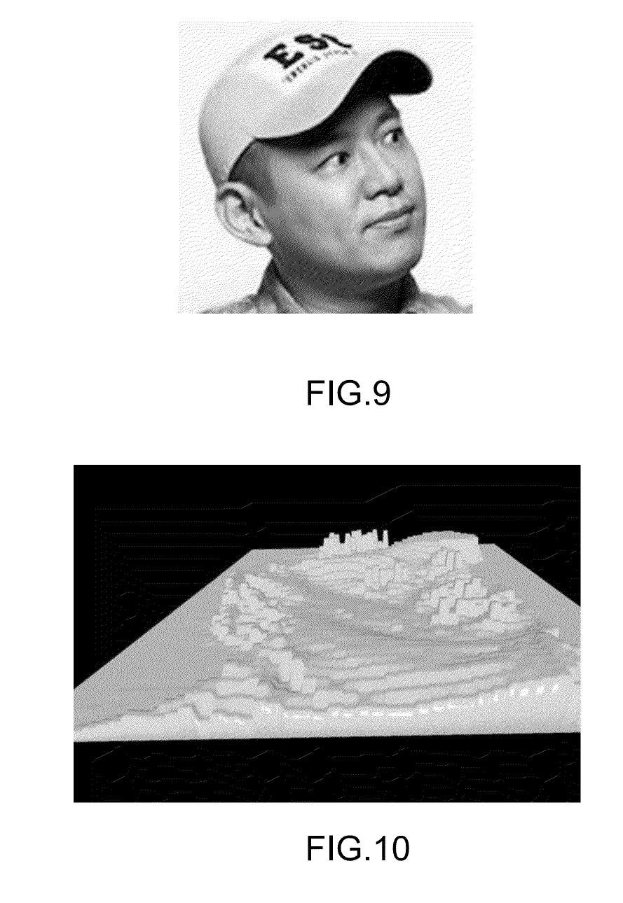

Step S202: apply a gray-scale processing to the two-dimension image 100. Preferably, if the two-dimension image 100 is of color image type, i.e. a color two-dimension image as FIG. 7 that has both color variation and brightness variation, the processing unit 12 applies the gray-scale processing to the two-dimension image, e.g. downscaling the color depth of the two-dimension image from 24-bit true color to 8-bit gray-scale, to convert the two-dimension image 100 into a gray-scale two-dimension image 100, i.e. a gray-scale image only having brightness variation as illustrated in FIG. 9.

Step S204: apply a smoothing processing to the gray-scale two-dimension image 100 to generate smoothed two-dimension image 100. Preferably, the major objective for performing the smoothing processing is to decrease accuracy of the gray-scale two-dimension image to decrease high-frequency component, i.e. to generate high-frequency distortion, to decrease lines in the generated three-dimension model.

Human eyes are like a low-pass filter, i.e. more sensitive to low-frequency components (the profiles in the image) than to high-frequency components (the details in the image). In other words, smoothing processing in the embodiment causes high-frequency distortion, but does not affect overall visual effect of the gray-scale two-dimension image 100. In addition, the complexity of the three-dimension model is also lowered down due to high frequency distortion. Furthermore, the physical three-dimension models generated according to the three-dimension model also have lower noises.

Preferably, the smoothing processing may be resolution-lowering processing, Mosaic processing, Binarization processing or grid processing (explained as follows), but the disclosed example is not limited to these examples.

Step S206: apply a height calculation to the two-dimension image 100 to construct the three-dimension model. Specifically, the processing unit 12 may respectively calculate a height value for each pixel according to the pixel values of the multiple pixels of the smoothed two-dimension image 100. Next, a height-stretching is applied to each pixel of the smoothed two-dimension image 100 according to the height values to construct the three-dimension model as illustrated in the three-dimension model of FIG. 10 in which each pixel has a corresponding ascending of associated height value.

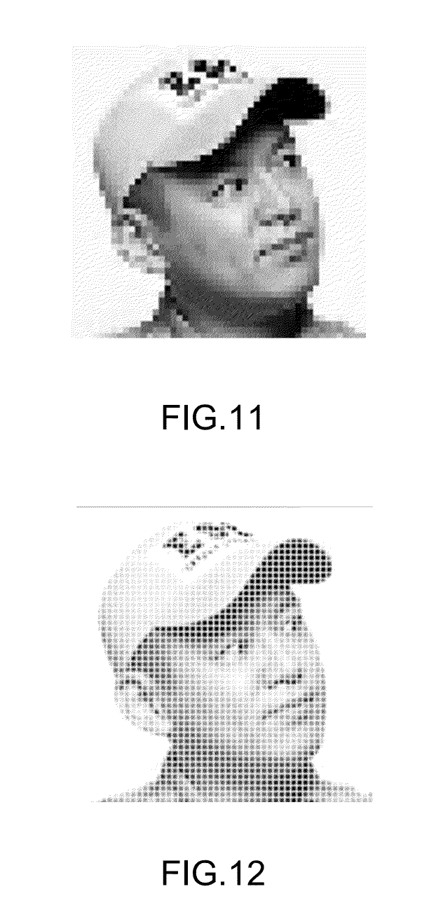

Next, the gray-scale two-dimension image 100 (as FIG. 9) is applied a resolution-lowering processing to generate the smoothed two-dimension image 100 (as FIG. 11), as an example to explain the resolution-lowering implementation method. Specifically, the resolution-lowering processing is combining or deleting multiple pixels in the gray-scale two-dimension image 100 (e.g. combining 16 pixels into 1 pixel or deleting pixels at specific positions) so that the resolution of the gray-scale two-dimension image 100 is lowered to a specific size (e.g. 512 pixels×512 pixels) to achieve the objective of resolution lowering for the gray-scale two-dimension image 100.

In other words, the resolution lowering processing is to keep printing size of the gray-scale two-dimension image 100 but meanwhile to decrease Dot-Per-Inch (DPI) or Pixel-Per-Inch (PPI) of the gray-scale two-dimension image 100.

Besides, in another embodiment, the smoothing processing may be a Mosaic processing. The Mosaic processing is to perform re-sampling to the multiple pixels of the two-dimension image 100 to squarelize the gray-scale two-dimension image 100 to achieve decreasing accuracy of the gray-scale two-dimension image 100.

For example, the processing module 120 firstly divides the gray-scale two-dimension image 100 into multiple blocks and each block separately contains 16 pixels. Next, the processing module 120 re-samples the pixels in each block so that the pixel values of pixels in each block keep the same. With such, the accuracy of the gray-scale two-dimension image 100 is decreased by squarelization.

Next, in another embodiment of the disclosed example, the smoothing processing may be a binarization processing. The binarization processing is to convert the gray-scale two-dimension image 100 into a halftone image that only has black and white colors to decrease accuracy of the gray-scale two-dimension image 100 by generating high-frequency distortion. Preferably, the binarization processing is achieved by performing ordered dithering method or error diffusion method, but the disclosed example is not limited to such examples.

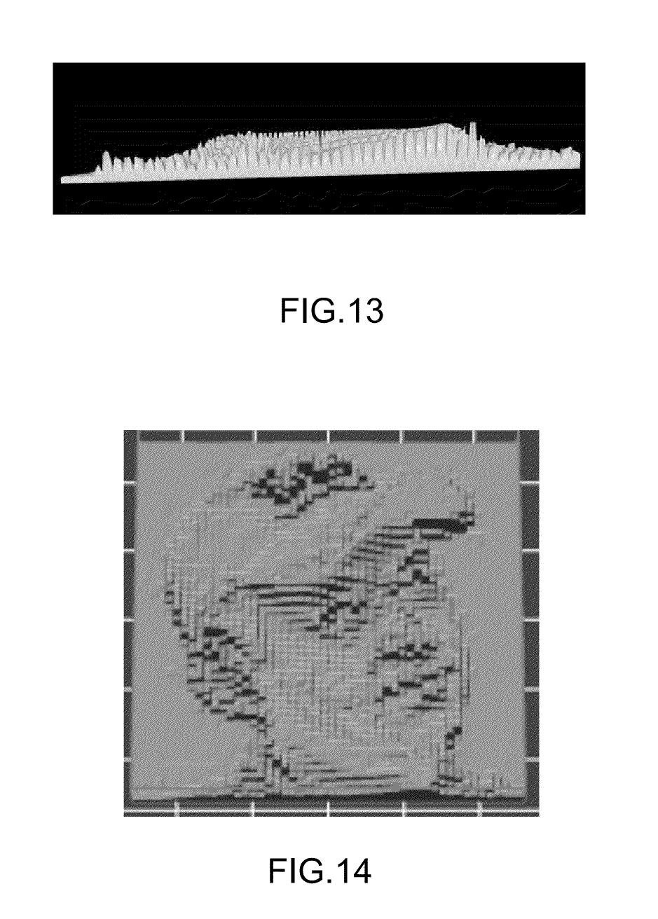

Besides, in another embodiment, the smoothed two-dimension image 100 as illustrated in FIG. 12 may be obtained by performing grid processing to the gray-scale two-dimension image 100 as illustrated in FIG. 9. Specifically, the grid processing is performed by replacing a portion of pixels of the gray-scale two-dimension image 100 with net of white lines to decrease accuracy of the gray-scaled two-dimension image 100. In addition, the smoothed two-dimension image 100 is constructed to the three-dimension model (after step S206) to generate net-shape trenches corresponding to the net of white lines, i.e. the pixels at positions of the net of white lines having lower height so as forming net-shape trenches in the three-dimension model as illustrated in FIG. 13.

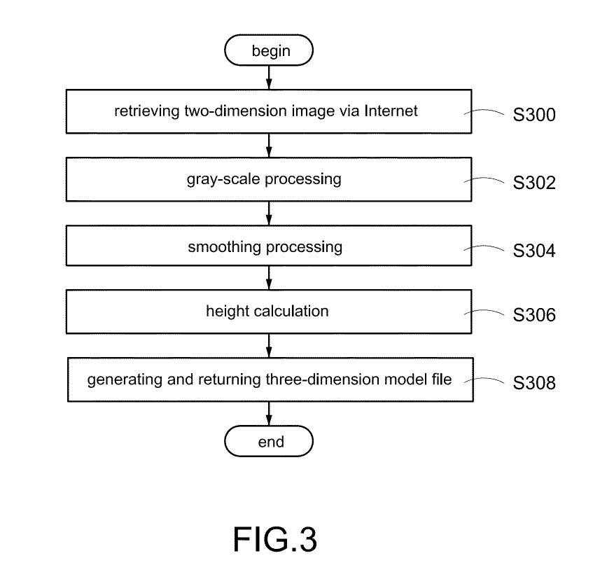

Please refer to FIG. 3, which is a flowchart of an image processing method according to a second embodiment of the disclosed example. The image processing method is mainly implemented by the image processing system 1 of FIG. 1. In this embodiment, the image processing system 1 is a server and connects to the Internet via the communication unit 14 for providing cloud service to convert two-dimension images to three-dimension models. The processing unit 12 executes the computer program 102 to perform the following steps.

Step S300: receive the two-dimension image 100 from a user over the Internet via the communication unit 14 and the two-dimension image 100 is stored in the memory unit 10.

Step S302: perform gray-scale processing to the two-dimension image 100 to generate the gray-scale two-dimension image 100.

Step S304: perform smoothing processing to the two-dimension image 100 to generate smoothed two-dimension image 100.

Step S306: perform height calculation processing to the smoothed two-dimension image to construct the three-dimension model.

Step S308: generate the three-dimension model file according to the three-dimension model and return the three-dimension model file to the user over the Internet.

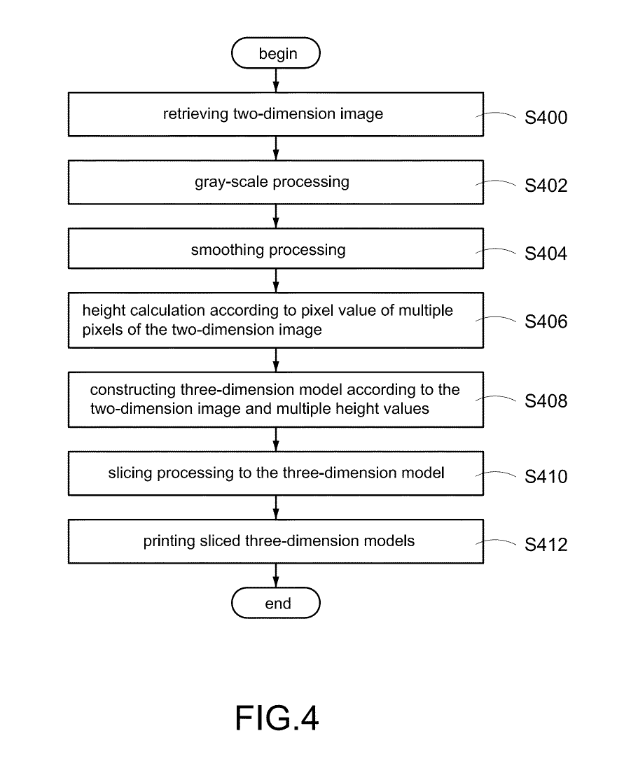

Next, please refer to FIG. 4, which is a flowchart of an image processing method according to a third embodiment of the disclosed example. The image processing method may be implemented by the image processing system 1 of FIG. 1. In this embodiment, the output unit 16 is a three-dimension printer. When the processing unit 12 executes the computer program 102, the following steps are performed.

Step S400: retrieving the two-dimension image 100.

Step S402: perform gray-scale processing to the two-dimension image to generate the gray-scale two-dimension image.

Step S404: perform smoothing processing to the gray-scale two-dimension image 100 to generate the smoothed two-dimension image 100.

Step S406: calculate multiple height values corresponding to the multiple pixels according to the pixel values of multiple pixels of the two-dimension image 100. Specifically, the processing unit 12 respectively calculates the height value of each pixel according to the pixel value of each pixel of the smoothed two-dimension image 100. Preferably, each pixel value is inversely proportionally to the corresponding height value.

For example, if the smoothed two-dimension image 100 has a color depth of 8 bits (i.e. each pixel value ranging between 0-255), when a pixel has a pixel value of 250, the height calculation module 126 sets the height value of associated pixel as 5 (i.e. the result by minus 250 from 255).

In another example, if the smoothed two-dimension image 100 has a color depth of 8 bits and the pixel value is changed to 200, the height calculation module 126 sets the height value of the associated pixel as 55 (i.e. the result by minus 200 from 255).

In other words, if the pixel has larger value (i.e. brighter pixel), the pixel corresponds to a smaller height value (i.e. with lesser thickness at associated position of the pixel in the three-dimension model). If the pixel has smaller value (i.e. darker pixel), the pixel corresponds to a larger height value (i.e. with larger thickness at associated position of the pixel in the three-dimension model).

Step 408: construct the three-dimension model according to the two-dimension image 100 and the multiple height values. Specifically, the processing unit 12 respectively generates ascending height according to the height value at position of corresponding pixel to convert the two-dimension image 100 to a three-dimension model. In FIG. 14, the three-dimension model shows a squarelized visual effect by smoothing processing and shows visual effect of gradation of light and shadow by ascending heights according to the pixel value calculation.

Step S410: perform slicing processing to the three-dimension model to generate the slice three-dimension model. Specifically, the slicing processing is to slice the three-dimension model into multiple slice models. These slice models have the same thickness. In addition, each slice model is respectively printed out as a slice physical model by the three-dimension printer (to be further explained as follows).

In other words, if the maximum height of the three-dimension model has larger value, there are more slice models. If the maximum height of the three-dimension model has smaller value, there are less slice models.

Furthermore, in the three-dimension model, if the ascending height is taller corresponding to the position of the pixel (i.e. with larger height value), more slices may be generated via slicing processing. If the ascending height is lower corresponding to the position of the pixel (i.e. with smaller height value), less slices may be generated via slicing processing.

During slicing processing, the slicing module 128 may further compute a printing path (i.e. the moving path of a printer head of the three-dimension printer) corresponding to these slice models. Preferably, the slicing module 128 calculates the printing path according to perpendicular direction of the slicing for these slice models (the X-axial direction, Y-axial direction, Z-axial direction or other direction of the three-dimension model). In other words, if these slice models are stacked according to the printing path, the three-dimension model is obtained.

Step S412: print the slice three-dimension models by the three-dimension printer to create the physical three-dimension model. Specifically, the processing unit 12 transmits the slice three-dimension models and the printing path to the three-dimension printer. Next, the three-dimension printer prints the slice models sequentially according to the printing path to create the physical three-dimension model.

Specifically, the three-dimension printer only prints a set of the slice model. The printed slice physical three-dimension model as a specific thickness, e.g. 0.3 mm. The three-dimension printer moves the printer head according to the printing path to print the slice model so that the printed slice physical models may be stacked to obtain the physical three-dimension model.

In other words, if there are more slice models, there are more slice physical models and the thickness of the stacked three-dimension model is larger. If there are less slice models, there are less slice physical models and the stacked three-dimension model is thinner.

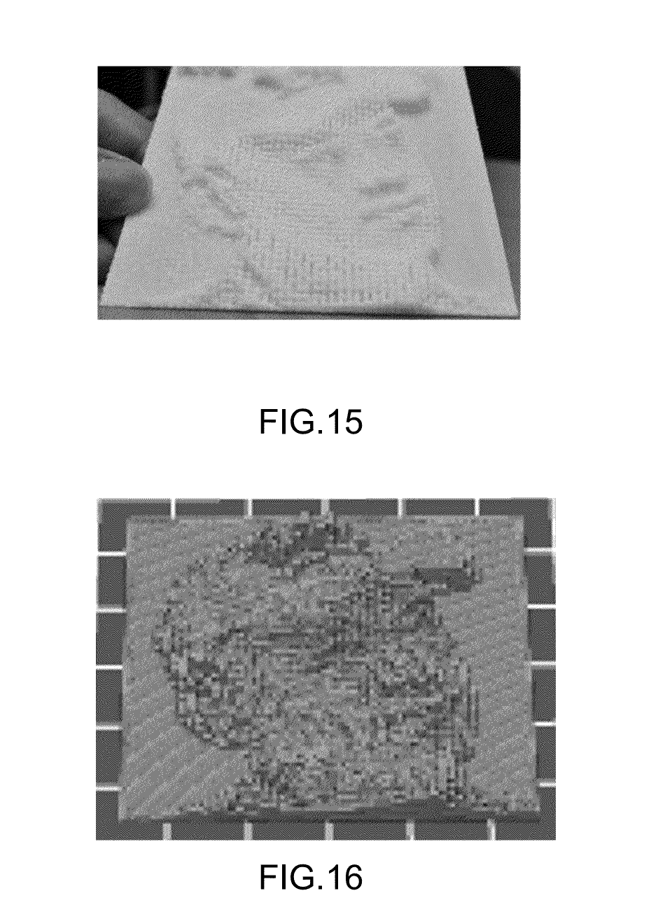

Please be noted that the three-dimension model has different thickness at different positions. In other words, the physical three-dimension model created and illustrated as FIG. 15 appears like a cameo physical model and shows visual effect as if the smoothed two-dimension image 100 is carved at a plate. Besides, when the physical three-dimension model is emitted with a back light source, transmitted light is different at different positions due to thickness difference. By such, the physical three-dimension model created by the disclosed example may provide the same visual effect of gradation of light and shadow as the two-dimension image 100 with different transmitted light amount.

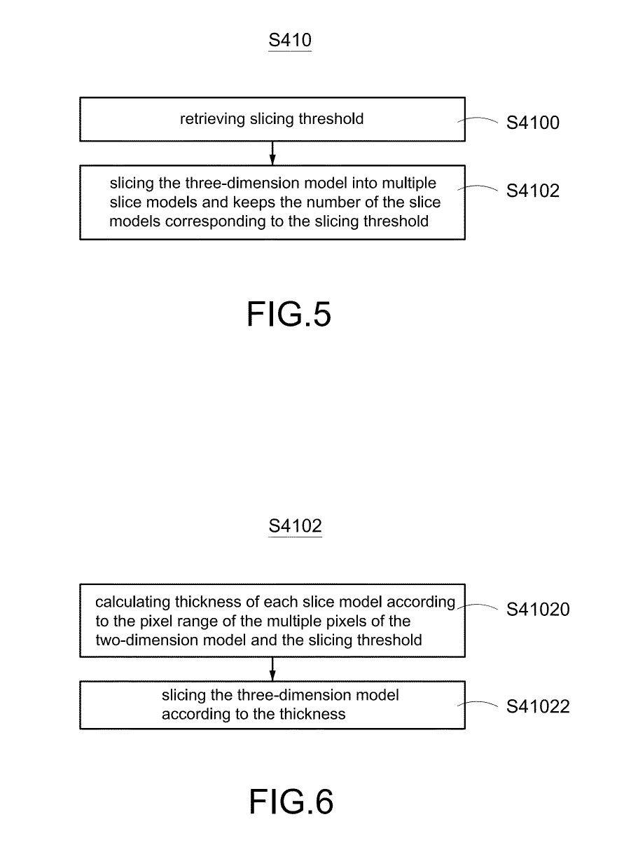

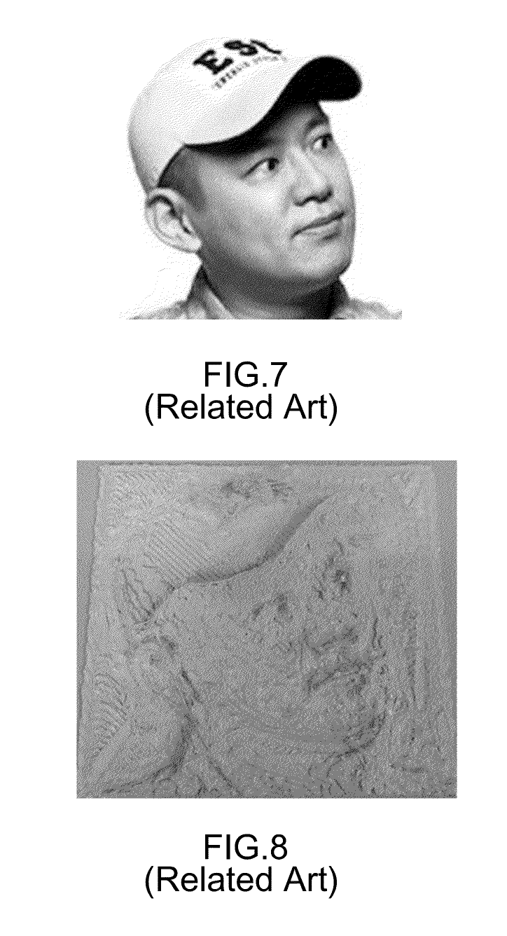

Please refer to FIG. 5, which is a detailed flowchart of the step S410 of the third embodiment.

Step S4100: the processing unit 12 retrieves a slicing threshold. Preferably, the slicing threshold is predetermined and stored in the memory unit 10, but the disclosed example is not limited to such example.

Step S4102: the processing unit 12 slices the three-dimension model into multiple slice models and the number of the slice models is the same as the slicing threshold.

For example, if the slicing threshold is 15, the processing unit 12 slices the three-dimension model into 15 sets of the slice models. If the slicing threshold is 120, the processing unit 12 slices the three-dimension model into 120 sets of slice models.

By such, even the input two-dimension images 100 are different, i.e. with different maximum height values for corresponding three-dimension model, the physical three-dimension models may still have the same thickness, with the same printing slices and the same thickness of each slice via the disclosed example.

Please refer to FIG. 6, which is a detailed flowchart for step S4102 of the third embodiment of the disclosed example.

Step S41020: the processing unit 12 calculates a thickness value of the slice model according to the pixel value range of the multiple pixels of the smoothed two-dimension image 100 and the slicing threshold. Specifically, the processing unit calculates the thickness according to Equation 1 defined as follows.

Thickness=pixel value range/slicing threshold (Equation 1)

Step S41022: the processing unit 12 slices the three-dimension model according to the thickness so that multiple slice models have the number equals to the slicing threshold. Specifically, the processing unit 12 re-calculates height value of each pixel in the two-dimension image 100 according to the thickness so that the maximum height value is equal to the slicing threshold and the thickness of each slice model is equal to the thickness. Next, the processing unit 12 slices the three-dimension model according to the re-calculated height value. Compared with the non-slice three-dimension model as illustrated in FIG. 14, the slice three-dimension model as illustrated in FIG. 16 shows more depth and apparent image features, e.g. the facial profile of the figure of the two-dimension image of FIG. 7.

For example, if the smoothed two-dimension image 100 has a largest pixel value of 255 for the multiple pixels, the slicing threshold is 17. The processing unit 12 may calculate the thickness for each slice as 15 according to the Equation 1. Next, the processing unit 12 divides the pixel value for each pixel with the thickness and uses the divider as the new height value. For example, if the pixel value is 170, the new height value is obtained by dividing 170 with 17 to obtain 10. If the pixel value is 33, the new height value is obtained by dividing 33 with 17 to get 1.

In another example, if the smoothed two-dimension image 100 has maximum pixel value of 170 for the multiple pixels, the slicing threshold is 17. The processing unit 12 calculates and obtains the thickness as 10 for each slice according to the equation 1. Next, the processing unit 12 divides pixel value of each pixel by the thickness and uses the divider as the new height value. For example, if the pixel value is 170, the new height value is obtained by dividing 170 with 10 to obtain 17. If the pixel value is 33, the new height value is 3 by dividing 33 with 10.

As mentioned above, the pixel value range of the two-dimension image may be used for calculating the height value. Therefore, even different images may contain the same pixel value, e.g. pixel value of 33, there may be different height values corresponding to the pixel value for different images because these images have different light and shadow characteristic, i.e. different pixel value ranges.

In other words, these embodiments effectively converts dynamic range, i.e. the pixel value range between the maximum pixel value and the minimum pixel value of the two-dimension image 100, into height value range of the three-dimension model, i.e. the value range between the maximum height value and minimum height value of the three-dimension model. By such, the physical three-dimension model may effectively appear image features of the two-dimension image 100.

In summary, these embodiments calculate heights of a smoothed two-dimension image to effectively simplify lines of the constructed three-dimension model so as to obtain a physical three-dimension model with less noise and deeper image features. Furthermore, the three-dimension model is sliced with the thickness to effectively create physical three-dimension models with the same thickness. In addition, the physical three-dimension physical models effectively show full dynamic range of the two-dimension images. Even a user does not have skill of three-dimension model building, the user may still obtain a three-dimension model.

The foregoing descriptions of embodiments of the disclosed example have been presented only for purposes of illustration and description. They are not intended to be exhaustive or to limit the disclosed example to the forms disclosed. Accordingly, many modifications and variations will be apparent to practitioners skilled in the art. Additionally, the above disclosure is not intended to limit the disclosed example. The scope of the disclosed example is defined by the appended

What is claimed is:

1. A method for image processing, comprising:
a) retrieving a two-dimension image;
b) performing a gray-scale processing to the two-dimension image;
c) performing a smoothing processing to the two-dimension image;
d) respectively calculating a height value corresponding to each pixel according to pixel values of a plurality of pixels of the two-dimension image, wherein the pixel value of each pixel is inversely proportional to the corresponding height value; and
e) constructing a three-dimension model according to the two-dimension image and the plurality of the height values.

2. The image processing method of claim 1, wherein in the step a), the two-dimension image is received via the Internet.

3. The image processing method of claim 2, further comprising: f) generating and returning a three-dimension model file according to the three-dimension model.

4. The image processing method of claim 1, wherein in the step c), the smoothing processing is resolution lowering, Mosaic processing, Binarization processing or grid processing.

5. The image processing method of claim 1, further comprising: g) performing slicing processing to the three-dimension model.

6. The image processing method of claim 5, wherein the step g) comprises:
g1) retrieving a slicing threshold; and
g2) slicing the three-dimension model into a plurality of slice models, wherein the number of the plurality of slice models corresponds to slicing threshold.

7. The image processing method of claim 6, wherein the step (g2) comprises:
g21) calculating a thickness value for each slice model according to a pixel value range and the slicing threshold of the plurality of pixels of the two-dimension image; and
g22) slicing the three-dimension model according to the thickness value.

8. The image processing method of claim 7, wherein the step g22) comprises:
g221) calculating the height value corresponding to each pixel of the two-dimension image according to the thickness value so that the maximum height value being corresponding to the slicing threshold; and
g222) slicing the three-dimension model according to the plurality of height values.

9. The image processing method of claim 5, further comprising step h): printing the three-dimension model after slicing processing.
